(19) United States
(12) Patent Application Publication
(10) Pub. No.: US 2020/0392971 A1
(43) Pub. Date: Dec. 17, 2020

(54) ELECTRIC SUPERCHARGER

(71) Applicant: KABUSHIKI KAISHA TOYOTA JIDOSHOKKI, Aichi-ken (JP)

(72) Inventors: Kana KIYOSUMI, Aichi-ken (JP); Makio OSHITA, Aichi-ken (JP)

(73) Assignee: KABUSHIKI KAISHA TOYOTA JIDOSHOKKI, Aichi-ken (JP)

(21) Appl. No.: 16/892,744

(22) Filed: Jun. 4, 2020

(30) Foreign Application Priority Data
Jun. 12, 2019 (JP) 2019-109552

(51) Int. Cl. F04D 29/58; F04D 25/06; F02B 33/40

(52) U.S. Cl. CPC F04D 29/5806; F04D 25/06; F05B 2260/232; F05B 2220/40; F02B 33/40

(57) ABSTRACT

An electric supercharger includes a housing, a rotary shaft, an impeller, and an electric motor. The housing includes a peripheral wall that has a cylindrical shape. The electric motor includes a stator in which a coil is wound. The stator includes a stator core having a cylindrical shape, and a first coil end and a second coil end. A plurality of first oil supply holes are formed in the peripheral wall in a state where openings of the first oil supply holes on a side of the first coil end are arranged side by side in a circumferential direction of the rotary shaft. A plurality of second oil supply holes are formed in the peripheral wall in a state where openings of the second oil supply holes on a side of the second coil end are arranged side by side in the circumferential direction of the rotary shaft.

### CROSS-REFERENCE TO RELATED APPLICATION

This application claims priority to Japanese Patent Application No. 2019-109552 filed on Jun. 12, 2019, the entire disclosure of which is incorporated herein by reference.

### BACKGROUND ART

The present disclosure relates to an electric supercharger in which an impeller is rotated by rotation of a rotary shaft in response to drive of an electric motor.

The electric supercharger includes a housing having a cylindrical peripheral wall, and a rotary shaft and an electric motor that rotates the rotary shaft are housed in the housing. An impeller is connected to an axial end of the rotary shaft. In the electric supercharger, the impeller is rotated by the rotation of the rotary shaft in response to drive of the electric motor. The electric motor includes a stator in which a coil is wound. The stator has a cylindrical stator core, and a first coil end and a second coil end that are parts of the coil and project from both end surfaces of the stator core located in the axial direction of the rotary shaft.

As the coil of the electric motor tends to generate heat to have a high temperature, it is necessary to efficiently cool the coil. For example, the electric supercharger disclosed in Japanese Patent Application Publication No. 2018-193858 includes a first oil supply hole opened on an inner peripheral surface of a peripheral wall at a position overlapping a first coil end in a radial direction of a rotary shaft, and a second oil supply hole opened on the inner peripheral surface of the peripheral wall at a position overlapping a second coil end in the radial direction of the rotary shaft. The first coil end is cooled by oil supplied from the first oil supply hole to the first coil end, and the second coil end is cooled by oil supplied from the second oil supply hole to the second coil end. As a result, the coil is efficiently cooled.

The electric supercharger disclosed in Japanese Patent Application Publication No. 2018-193858 includes one first oil supply hole opened on an inner peripheral surface of a peripheral wall at a position overlapping a first coil end in a radial direction of a rotary shaft, and one second oil supply hole opened on the inner peripheral surface of the peripheral wall at a position overlapping a second coil end in the radial direction of the rotary shaft. If the posture of an object in which the electric supercharger is to be mounted is changed, the entire electric supercharger may be tilted so as to turn about a virtual straight line extending parallel to the axis of the rotary shaft, the virtual straight line functioning as a turning center. In this case, the oil flowing from the first oil supply hole to the first coil end may flow unevenly toward one side in a circumferential direction of the rotary shaft, or the oil flowing from the second oil supply hole to the second coil end may flow unevenly toward one side in the circumferential direction of the rotary shaft. The entire first coil end becomes hard to be cooled uniformly by the oil supplied from the first oil supply hole to the first coil end, and the entire second coil end also becomes hard to be cooled uniformly by the oil supplied from the second oil supply hole to the second coil end. As a result, the coil of the electric motor is not efficiently cooled.

The present disclosure has been achieved in order to solve the above problem, and is directed to providing an electric supercharger capable of efficiently cooling a coil of an electric motor.

### SUMMARY

In accordance with an aspect of the present disclosure, an electric supercharger includes a housing, a rotary shaft, an impeller, and an electric motor. The housing includes a peripheral wall that has a cylindrical shape. The rotary shaft is housed in the housing. The impeller is connected to an axial end of the rotary shaft. The electric motor is housed in the housing and rotates the rotary shaft. The electric motor includes a stator in which a coil is wound. The stator includes a stator core having a cylindrical shape, and a first coil end and a second coil end that are parts of the coil and project from both end surfaces of the stator core located in an axial direction of the rotary shaft. The peripheral wall includes a plurality of first oil supply holes through which oil flows and a plurality of second oil supply holes through which oil flows. The first oil supply holes are opened on an inner peripheral surface of the peripheral wall at positions overlapping the first coil end in a radial direction of the rotary shaft.

The second oil supply holes are opened on the inner peripheral surface of the peripheral wall at positions overlapping the second coil end in the radial direction of the rotary shaft. The plurality of first oil supply holes are formed in the peripheral wall in a state where openings of the first oil supply holes on a side of the first coil end are arranged side by side in a circumferential direction of the rotary shaft. The plurality of second oil supply holes are formed in the peripheral wall in a state where openings of the second oil supply holes on a side of the second coil end are arranged side by side in the circumferential direction of the rotary shaft.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a longitudinal-sectional side view illustrating an electric supercharger according to an embodiment;

FIG. 2 is an enlarged longitudianl-sectional view of a vicinity of a first bearing in the electric supercharger;

FIG. 3 is an enlarged longitudinal-sectional view of a vicinity of a second bearing in the electric supercharger;

FIG. 4 is an enlarged longitudianl-sectional view of a part of the electric supercharger;

FIG. 5 is a cross-sectional view taken along a line 5-5 in FIG. 4;

FIG. 6 is a cross-sectional view taken along a line 6-6 in FIG. 4; and

FIGS. 7A and 7B are cross-sectional views illustrating a state where the entire electric supercharger is tilted.

### DETAILED DESCRIPTION OF THE EMBODIMENTS

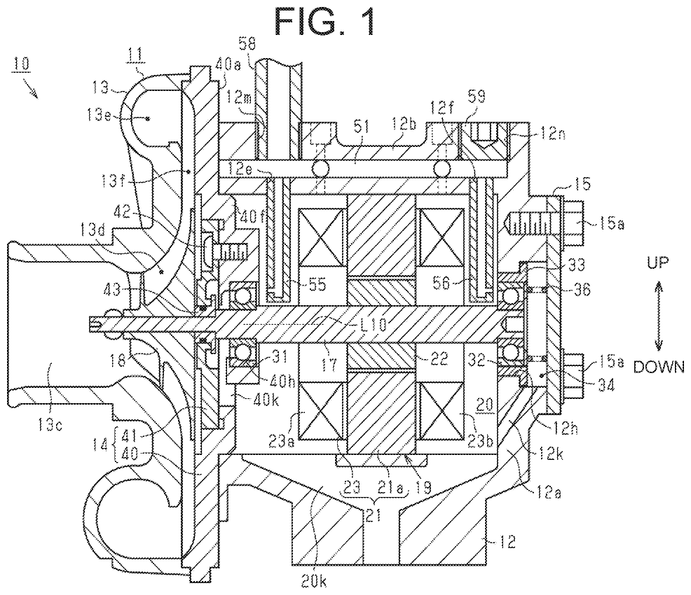

Hereinafter, an embodiment embodying an electric supercharger will be described with reference to FIGS. 1 to 7B. The electric supercharger according to the present embodiment is mounted in an engine room of an automobile, and is used for compressing and supplying air as a fluid to an engine. The automobile is thus an object in which the electric supercharger according to the present embodiment is to be mounted.

As illustrated in FIG. 1, a housing 11 of an electric supercharger 10 includes a motor housing 12, a compressor housing 13, a plate 14, and a cover 15. The motor housing 12, the compressor housing 13, the plate 14, and the cover 15 are made of metal, for example, aluminum.

The motor housing 12 has a bottomed cylindrical shape and includes a disk-shaped bottom wall 12a, and a peripheral wall 12b extending from an outer peripheral part of the bottom wall 12a and having a cylindrical shape. Consequently, the housing 11 has a cylindrical shape. A through-hole 12h is formed in a center part of the bottom wall 12a. The cover 15 has a flat plate shape, and is attached to an outer surface of the bottom wall 12a with bolts 15a so as to close the through-hole 12h.

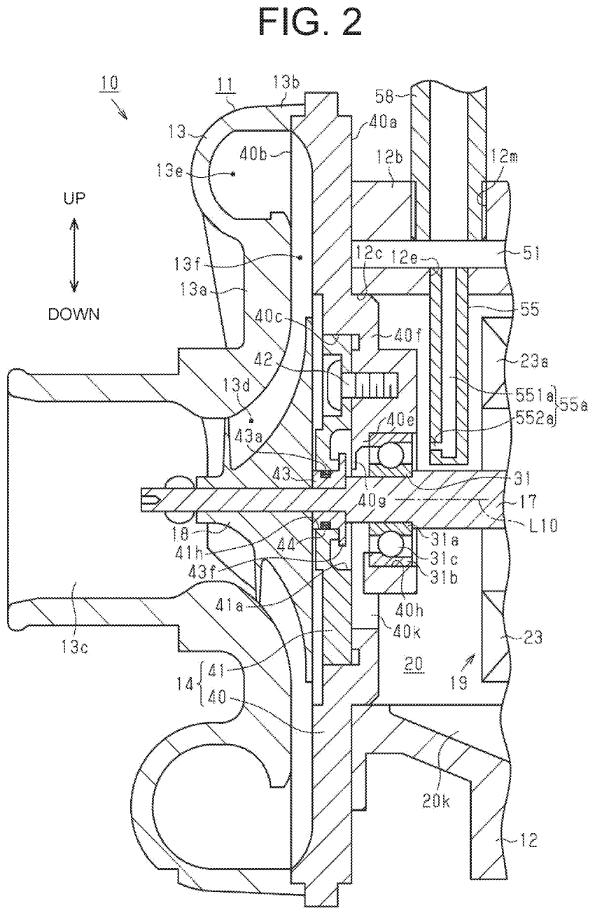

As illustrated in FIG. 2, the plate 14 includes a disk-shaped seal plate 40 and a disk-shaped retainer 41. The seal plate 40 is connected to an end of the peripheral wall 12b of the motor housing 12 opposite to the bottom wall 12a. The seal plate 40 includes a cylindrical fitting part 40f projecting from a center part of an end surface 40a of the seal plate 40 on a side of the motor housing 12. The seal plate 40 is connected to the motor housing 12 with the fitting part 40f fitted into an opening 12c of the motor housing 12 opposite to the bottom wall 12a. The fitting part 40f is fitted into the opening 12c to close the opening 12c of the motor housing 12.

A bearing holding hole 40h is formed in the fitting part 40f of the seal plate 40. An annular engaging part 40e projects from an inner peripheral surface of the bearing holding hole 40h farthest from a projecting end surface of the fitting part 40f.

The compressor housing 13 is connected to the seal plate 40 on a side opposite to the motor housing 12 with respect to the seal plate 40. The compressor housing 13 includes a substantially disk-shaped bottom wall 13a and a peripheral wall 13b extending from an outer peripheral part of the bottom wall 13a in a cylindrical shape. An opening of the peripheral wall 13b opposite to the bottom wall 13a is closed by the seal plate 40.

As illustrated in FIG. 1, the electric supercharger 10 includes a rotary shaft 17 housed in the housing 11 and rotatably supported by the housing 11. One axial end of the rotary shaft 17 passes through the plate 14 to project into the compressor housing 13. An impeller 18 is connected to the one end of the rotary shaft 17. Consequently, the impeller 18 is connected to the axial end of the rotary shaft 17. The other axial end of the rotary shaft 17 is located inside the through-hole 12h.

The compressor housing 13 includes an inlet port 13c through which air (fresh air) is taken, an impeller chamber 13d communicating with the inlet port 13c and housing the impeller 18, a discharge chamber 13e into which air compressed by the impeller 18 is discharged, and a diffuser flow path 13f causing the impeller chamber 13d to communicate with the discharge chamber 13e. The plate 14 cooperates with the compressor housing 13 to define the impeller chamber 13d.

An electric motor 19 for rotating the rotary shaft 17 is housed in the motor housing 12. The electric motor 19 is housed in a motor chamber 20 that is a space surrounded by the bottom wall 12a and the peripheral wall 12b of the motor housing 12, and the plate 14. The electric motor 19 includes a cylindrical stator 21 and a cylindrical rotor 22 disposed inside the stator 21. A coil 23 is wound in the stator 21. When a current is supplied to the coil 23, the rotor 22 rotates integrally with the rotary shaft 17.

The stator 21 includes a cylindrical stator core 21a fixed to an inner peripheral surface of the peripheral wall 12b of the motor housing 12, and a first coil end 23a and a second coil end 23b that project respectively from both end surfaces of the stator core 21a located in the axial direction of the rotary shaft 17.

The first coil end 23a projects from an end surface of the stator core 21a located on a side of the plate 14 in the axial direction of the rotary shaft 17. The second coil end 23b projects from an end surface of the stator core 21a located on a side of the bottom wall 12a of the motor housing 12 in the axial direction of the rotary shaft 17. The first coil end 23a and the second coil end 23b are parts of the coil 23.

As illustrated in FIG. 2, the electric supercharger 10 includes a first bearing 31 that rotatably supports a portion of the rotary shaft 17 between the electric motor 19 and the impeller 18 with respect to the housing 11. The first bearing 31 is held in the bearing holding hole 40h. The portion of the rotary shaft 17 between the electric motor 19 and the impeller 18 is rotatably supported by the seal plate 40 via the first bearing 31.

The first bearing 31 is an angular ball bearing including a first inner race 31a fixed to an outer peripheral surface of the rotary shaft 17, a first outer race 31b disposed outside the first inner race 31a, and a plurality of spherical first rolling elements 31c disposed between the first inner race 31a and the first outer race 31b. The first inner race 31a is press-fitted into the outer peripheral surface of the rotary shaft 17. The first outer race 31b is press-fitted into the inner peripheral surface of the bearing holding hole 40h.

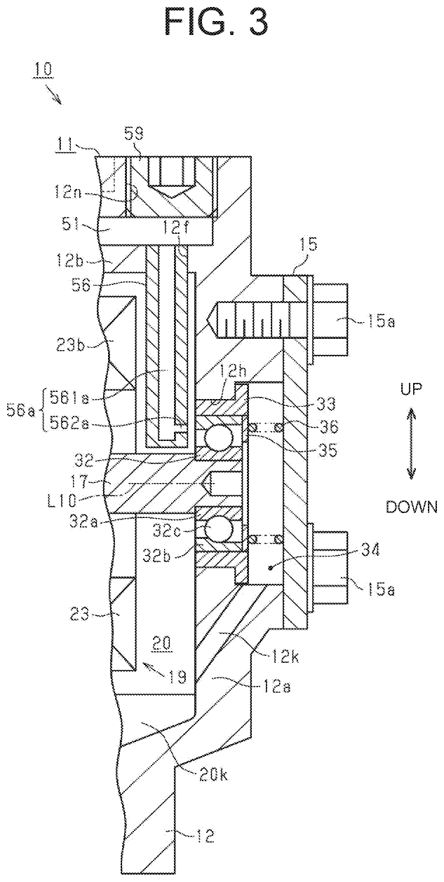

As illustrated in FIG. 3, the electric supercharger 10 includes a second bearing 32 that rotatably supports the other axial end of the rotary shaft 17 with respect to the housing 11. The other axial end of the rotary shaft 17 is a portion of the rotary shaft 17 on a side opposite to the impeller 18 with respect to the electric motor 19. The electric supercharger 10 also includes a cylindrical bearing holding sleeve 33 that holds the second bearing 32. The bearing holding sleeve 33 is made of iron. The bearing holding sleeve 33 is press-fitted into an inner peripheral surface of the through-hole 12h to be attached to the bottom wall 12a of the motor housing 12.

The second bearing 32 is disposed between the outer peripheral surface of the rotary shaft 17 and an inner peripheral surface of the bearing holding sleeve 33. The other end of the rotary shaft 17 is rotatably supported by the bottom wall 12a of the motor housing 12 via the second bearing 32 and the bearing holding sleeve 33. The rotary shaft 17 is thus rotatably supported by the housing 11 via the first bearing 31 and the second bearing 32.

The second bearing 32 is an angular ball bearing including a second inner race 32a fixed to the outer peripheral surface of the rotary shaft 17, a second outer race 32b disposed outside the second inner race 32a, and a plurality of spherical second rolling elements 32c disposed between the second inner race 32a and the second outer race 32b. The second inner race 32a is press-fitted into the outer peripheral surface of the rotary shaft 17. The second outer race 32b is loose-fitted into the inner peripheral surface of the bearing holding sleeve 33.

In the through-hole 12h, a housing chamber 34 is provided between the bearing holding sleeve 33 and the cover 15 in the axial direction of the rotary shaft 17. A washer 35 is provided inside the bearing holding sleeve 33 so as to contact an end of the second outer race 32b on a side of the housing chamber 34. A preload spring 36 is also housed in the housing chamber 34. The preload spring 36 is interposed between the washer 35 and the cover 15.

One end of the preload spring 36 abuts against the cover 15, and the other end of the preload spring 36 abuts against the washer 35. The preload spring 36 is disposed between the cover 15 and the washer 35 while being compressed in the axial direction of the rotary shaft 17. The cover 15 thus holds the preload spring 36. The preload spring 36 urges the second bearing 32 via the washer 35 in the axial direction of the rotary shaft 17 by force to return the preload spring 36 compressed to its original shape.

The urging force of the preload spring 36 is transmitted to the second outer race 32b via the washer 35, and the urging force transmitted to the second outer race 32b is transmitted to the second inner race 32a via the second rolling elements 32c. The second inner race 32a is thus pressed toward the impeller 18 in the axial direction of the rotary shaft 17. The urging force of the preload spring 36 is then transmitted from the second inner race 32a to the rotary shaft 17, and the rotary shaft 17 tends to move toward the impeller 18 in the axial direction of the rotary shaft 17. The rotary shaft 17 abuts against the first inner race 31a of the first bearing 31, and the first rolling elements 31c are pressed against the rotary shaft 17 toward the impeller 18 in the axial direction by the first inner race 31a, so as to press the first outer race 31b.

In the electric supercharger 10, when the impeller 18 rotates, thrust force is generated in the impeller 18 to pull the rotary shaft 17 in a direction from the second bearing 32 to the first bearing 31 in the axial direction of the rotary shaft 17. The first bearing 31 and the second bearing 32 rotatably support the rotary shaft 17 while receiving the thrust force via the rotary shaft 17.

When the electric motor 19 is driven to rotate the rotary shaft 17, the impeller 18 rotates, and the centrifugal force of the rotating impeller 18 gives velocity energy to the air taken from the inlet port 13c. The velocity of the air that has been increased by receiving velocity energy is reduced by the diffuser flow path 13f provided at an outlet of the impeller 18, and the velocity energy of the air is converted into pressure energy. The high-pressure air is then discharged from the discharge chamber 13e and supplied to an engine (not illustrated).

As illustrated in FIG. 2, a circular recess 40c is formed in an end surface 40b of the seal plate 40 on a side of the compressor housing 13. The inside of the recess 40c communicates with the bearing holding hole 40h. The retainer 41 is fitted into the recess 40c. The retainer 41 is attached to the seal plate 40 by a bolt 42 passing through the retainer 41 being screwed into a bottom surface of the recess 40c.

The retainer 41 has an insertion hole 41h through which the rotary shaft 17 is inserted. The insertion hole 41h is formed at a portion of the plate 14 closer to the impeller chamber 13d than the bearing holding hole 40h. A cylindrical seal collar 43 made of iron is disposed inside the insertion hole 41h. The seal collar 43 is attached to the outer peripheral surface of the rotary shaft 17 while being sandwiched between a step formed on the outer peripheral surface of the rotary shaft 17 and a back surface of the impeller 18. Consequently, the seal collar 43 rotates integrally with the rotary shaft 17.

An annular attachment groove 43a is formed in an outer peripheral surface of the seal collar 43. A metal seal ring 44 is attached to the attachment groove 43a. The seal ring 44 has a non-annular shape with a partial cut-away portion. The seal ring 44 is housed in the attachment groove 43a with its diameter reduced by the cut-away portion, and returns to its original shape in the attachment groove 43a, so that an outer peripheral surface of the seal ring 44 contacts an inner peripheral surface of the insertion hole 41h. The seal ring 44 thus seals the space between the attachment groove 43a and the insertion hole 41h.

A recess 41a is formed in an end surface of the retainer 41 on a bottom surface side of the recess 40c and around the insertion hole 41h. An annular flange 43f projects from an end of the outer peripheral surface of the seal collar 43 opposite to the impeller 18. The flange 43f is disposed inside the recess 41a of the retainer 41. The flange 43f cooperates with the seal ring 44 to function as a labyrinth seal.

The seal plate 40 includes a plate-shaped deflector 40g that projects radially inward of the rotary shaft 17 from a part of an inner peripheral surface of the engaging part 40e. The seal plate 40 has a first oil discharge passage 40k that causes the motor chamber 20 to communicate with a portion inside the engaging part 40e and on the opposite side to the deflector 40g in the radial direction of the rotary shaft 17. In addition, as illustrated in FIG. 3, a second oil discharge passage 12k is formed in the bottom wall 12a of the motor housing 12 so as to cause the housing chamber 34 to communicate with the motor chamber 20.

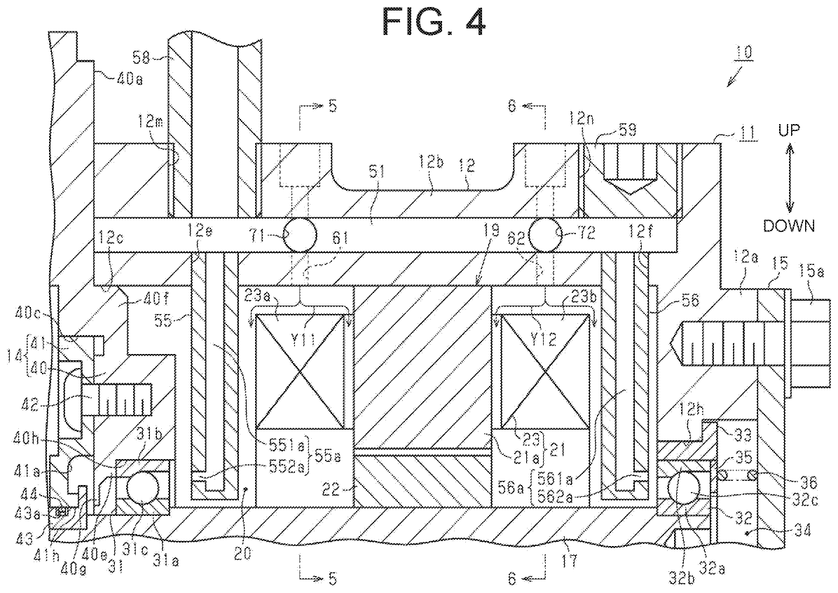

As illustrated in FIG. 4, an oil supply flow path 51 through which oil flows is formed in a part of the peripheral wall 12b of the motor housing 12. The oil supply flow path 51 has a circular hole shape. For example, the oil supply flow path 51 is formed by drilling an end surface of the peripheral wall 12b of the motor housing 12 on a side of the opening 12c. The oil supply flow path 51 extends in the axial direction of the rotary shaft 17 from the end surface of the peripheral wall 12b of the motor housing 12 on the side of the opening 12c to the bottom wall 12a. The opening of the oil supply flow path 51 on a side of the end surface of the peripheral wall 12b of the motor housing 12 on the side of the opening 12c is closed by the seal plate 40. An end of the oil supply flow path 51 on the side of the bottom wall 12a of the motor housing 12 is located at a position overlapping the through-hole 12h in the radial direction of the rotary shaft 17.

A first pipe attachment hole 12e and a second pipe attachment hole 12f are formed in the peripheral wall 12b of the motor housing 12. The first pipe attachment hole 12e and the second pipe attachment hole 12f have a circular hole shape. One end of the first pipe attachment hole 12e is opened near an end of the oil supply flow path 51 on a side of the seal plate 40. The other end of the first pipe attachment hole 12e is opened on the inner peripheral surface of the peripheral wall 12b of the motor housing 12 at a position overlapping, in the radial direction of the rotary shaft 17, a space between the electric motor 19 and the first bearing 31 in the axial direction of the rotary shaft 17. One end of the second pipe attachment hole 12f is opened near an end of the oil supply flow path 51 on the side of the bottom wall 12a of the motor housing 12. The other end of the second pipe attachment hole 12f is opened on the inner peripheral surface of the peripheral wall 12b of the motor housing 12 at a position overlapping, in the radial direction of the rotary shaft 17, a space between the electric motor 19 and the second bearing 32 in the axial direction of the rotary shaft 17.

A first connection hole 12m and a second connection hole 12n are formed in the peripheral wall 12b of the motor housing 12. The first connection hole 12m and the second connection hole 12n are circular female screw holes. The first connection hole 12m is located on the peripheral wall 12b of the motor housing 12 at a position overlapping the first pipe attachment hole 12e in the radial direction of the rotary shaft 17, One end of the first connection hole 12m is opened to the outer peripheral surface of the peripheral wall 12b of the motor housing 12, The other end of the first connection hole 12m is opened to the oil supply flow path 51. The first connection hole 12m extends in the radial direction of the rotary shaft 17. The hole diameter of the first connection hole 12m is larger than the hole diameter of the first pipe attachment hole 12e. The second connection hole 12n is located on the peripheral wall 12b of the motor housing 12 at a position overlapping the second pipe attachment hole 12f in the radial direction of the rotary shaft 17. One end of the second connection hole 12n is opened to the outer peripheral surface of the peripheral wall 12b of the motor housing 12. The other end of the second connection hole 12n is opened to the oil supply flow path 51. The second connection hole 12n extends in the radial direction of the rotary shaft 17. The hole diameter of the second connection hole 12n is larger than the hole diameter of the second pipe attachment hole 12f.

A first oil supply pipe 55 is attached to the first pipe attachment hole 12e, The first oil supply pipe 55 extends linearly, The first oil supply pipe 55 is attached to the peripheral wall 12b of the motor housing 12 by passing through the first connection hole 12m and the oil supply flow path 51 and causing one end to be press-fitted into the first pipe attachment hole 12e. The other end of the first oil supply pipe 55 passes through the first pipe attachment hole 12e to project into the motor chamber 20 between the electric motor 19 and the first bearing 31 in the axial direction of the rotary shaft 17, Consequently, the first oil supply pipe 55 is disposed between the electric motor 19 and the seal plate 40 in the axial direction of the rotary shaft 17. The first oil supply pipe 55 extends in the radial direction of the rotary shaft 17.

The first oil supply pipe 55 includes a first supply path 55a. The first supply path 55a includes a first in-shaft passage 551a extending in the first oil supply pipe 55 in an axial direction of the first oil supply pipe 55 and a first ejection hole 552a that communicates with the first in-shaft passage 551a and ejects oil to a space between the first inner race 31a and the first outer race 31b of the first bearing 31. One end of the first in-shaft passage 551a communicates with the oil supply flow path 51. Consequently, the first oil supply pipe 55 communicates with the oil supply flow path 51 near the one end of the oil supply flow path 51 in the axial direction of the rotary shaft 17, and supplies the oil from the oil supply flow path 51 to the first bearing 31. The first in-shaft passage 551a extends in the radial direction of the rotary shaft 17. The first ejection hole 552a extends in the axial direction of the rotary shaft 17. One end of the first ejection hole 552a communicates with an end of the first in-shaft passage 551a opposite to the oil supply flow path 51. The other end of the first ejection hole 552a is opened to an outer peripheral surface of the other end of the first oil supply pipe 55. The first ejection hole 552a faces a part of the space between the first inner race 31a and the first outer race 31b in the axial direction of the rotary shaft 17. The flow path cross-sectional area of the first ejection hole 552a is smaller than the flow path cross-sectional area of the first in-shaft passage 551a.

A second oil supply pipe 56 is attached to the second pipe attachment hole 12f. The second oil supply pipe 56 extends linearly. The second oil supply pipe 56 is attached to the peripheral wall 12b of the motor housing 12 by passing through the second connection hole 12n and the oil supply flow path 51 and causing one end to be press-fitted into the second pipe attachment hole 12f. The other end of the second oil supply pipe 56 passes through the second pipe attachment hole 12f to project into the motor chamber 20 between the electric motor 19 and the second bearing 32 in the axial direction of the rotary shaft 17. Consequently, the second oil supply pipe 56 is disposed between the electric motor 19 and the bottom wall 12a of the motor housing 12 in the axial direction of the rotary shaft 17. The second oil supply pipe 56 extends in the radial direction of the rotary shaft 17.

The second oil supply pipe 56 includes a second supply path 56a. The second supply path 56a includes a second in-shaft passage 561a extending in the second oil supply pipe 56 in an axial direction of the second oil supply pipe 56 and a second ejection hole 562a that communicates with the second in-shaft passage 561a and ejects oil to a space between the second inner race 32a and the second outer race 32b of the second bearing 32. One end of the second in-shaft passage 561a communicates with the oil supply flow path 51. Consequently, the second oil supply pipe 56 communicates with the oil supply flow path 51 near the other end of the oil supply flow path 51 in the axial direction of the rotary shaft 17, and supplies the oil from the oil supply flow path 51 to the second bearing 32. The second in-shaft passage 561a extends in the radial direction of the rotary shaft 17. The second ejection hole 562a extends in the axial direction of the rotary shaft 17. One end of the second ejection hole 562a communicates with an end of the second in-shaft passage 561a opposite to the oil supply flow path 51. The other end of the second ejection hole 562a is opened to an outer peripheral surface of the other end of the second oil supply pipe 56. The second ejection hole 562a faces a part of the space between the second inner race 32a and the second outer race 32b in the axial direction of the rotary shaft 17. The flow path cross-sectional area of the second ejection hole 562a is smaller than the flow path cross-sectional area of the second in-shaft passage 561a.

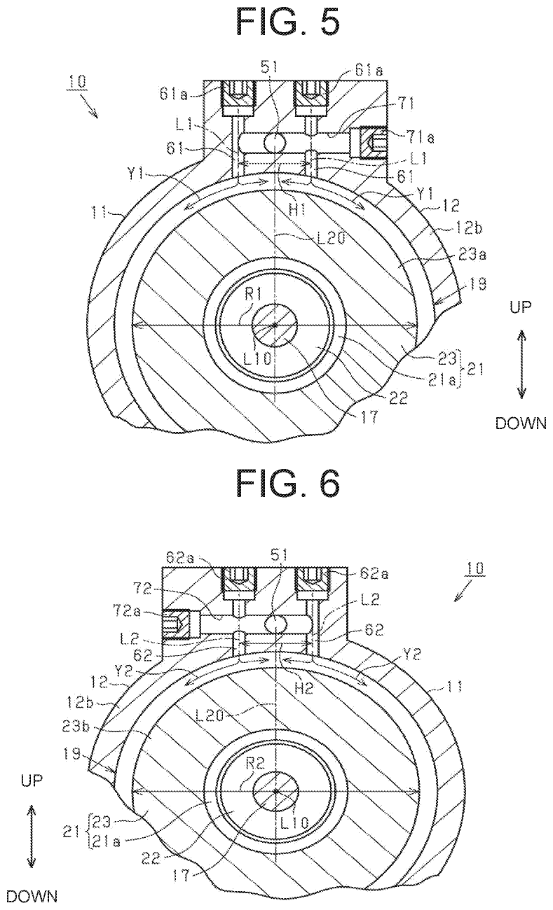

As illustrated in FIG. 4 and FIG. 5, the peripheral wall 12b of the motor housing 12 includes two first oil supply holes 61 through which oil flows. The first oil supply holes 61 have a circular hole shape, The first oil supply holes 61 are opened on the inner peripheral surface of the peripheral wall 12b at positions overlapping the first coil end 23a in the radial direction of the rotary shaft 17. Specifically, the first oil supply holes 61 are opened on the inner peripheral surface of the peripheral wall 12b at positions overlapping, in the radial direction of the rotary shaft 17, a center part of the first coil end 23a in the axial direction of the rotary shaft 17. A plurality of the first oil supply holes 61 are formed in the peripheral wall 12b in a state where openings of the first oil supply holes 61 on a side of the first coil end 23a are arranged side by side in a circumferential direction of the rotary shaft 17. In the present embodiment, the number of first oil supply holes 61 formed in the peripheral wall 12b is two.

The openings of the two first oil supply holes 61 on the side of the first coil end 23a are formed on the peripheral wall 12b so as to be at the same position in a direction of gravity when the electric supercharger 10 is disposed horizontally. The electric supercharger 10 according to the present embodiment is mounted in an engine room such that the openings of the two first oil supply holes 61 on the side of the first coil end 23a are at the same position in the direction of gravity. The electric supercharger 10 is mounted in the engine room such that the openings of the two first oil supply holes 61 on the side of the first coil end 23a are located above the rotary shaft 17 in the direction of gravity.

At a position on the peripheral wall 12b overlapping the first coil end 23a in the radial direction of the rotary shaft 17, a first relay flow path 71 is formed. The first relay flow path 71 is orthogonal to the oil supply flow path 51, communicates with the oil supply flow path 51, and extends in a direction intersecting with the radial direction of the rotary shaft 17. The first relay flow path 71 has a circular hole shape. The first relay flow path 71 extends in a direction orthogonal to the radial direction of the rotary shaft 17. For example, the first relay flow path 71 is formed by drilling the outer peripheral surface of the peripheral wall 12b. An opening of the first relay flow path 71 on a side of the outer peripheral surface of the peripheral wall 12b is closed by a closing member 71a.

As illustrated in FIG. 5, two first oil supply holes 61 communicate with the first relay flow path 71. The two first oil supply holes 61 extend in parallel with each other, and also extend in a direction orthogonal to the direction that the first relay flow path 71 extends and in a direction orthogonal to the axial direction of the rotary shaft 17. For example, the two first oil supply holes 61 are formed by drilling the outer peripheral surface of the peripheral wall 12b. The two first oil supply holes 61 are thus drilled holes that extend straight from the outer peripheral surface of the peripheral wall 12b to the inner peripheral surface of the peripheral wall 12b and penetrate the peripheral wall 12b. Openings of the two first oil supply holes 61 on the side of the outer peripheral surface of the peripheral wall 12b are closed by closing members 61a.

One of the two first oil supply holes 61 communicates with a middle portion of the first relay flow path 71. The other of the two first oil supply holes 61 communicates with an end of the first relay flow path 71 opposite to the opening of the first relay flow path 71 on the side of the outer peripheral surface of the peripheral wall 12b. Consequently, a part of the oil from the oil supply flow path 51 flows through the first relay flow path 71 into the two first oil supply holes 61. The two first oil supply holes 61 supply the oil to the first coil end 23a. In the present embodiment, a shortest distance H1 between axes L1 of the two first oil supply holes 61 is set to be about 1/6 of an outer diameter R1 of the first coil end 23a.

When the peripheral wall 12b is viewed in the axial direction of the rotary shaft 17, the electric supercharger 10 is mounted in the engine room such that one of the two first oil supply holes 61 is disposed on one side of both sides sandwiching a perpendicular line L20 that is orthogonal to an axis L10 of the rotary shaft 17 and extends in the direction of gravity, and the other of the two first oil supply holes 61 is disposed on the other side of the both sides sandwiching the perpendicular line L20. Consequently, when the peripheral wall 12b is viewed in the axial direction of the rotary shaft 17, one of the openings of the first oil supply holes 61 on the side of the first coil end 23a is disposed on each of the both sides sandwiching the perpendicular line L20.

As illustrated in FIG. 4 and FIG. 6, the peripheral wall 12b of the motor housing 12 includes two second oil supply holes 62 through which oil flows.

The second oil supply hole 62 have a circular hole shape. The second oil supply holes 62 are opened on the inner peripheral surface of the peripheral wall 12b at positions overlapping the second coil end 23b in the radial direction of the rotary shaft 17. Specifically, the second oil supply holes 62 are opened on the inner peripheral surface of the peripheral wall 12b at positions overlapping, in the radial direction of the rotary shaft 17, a center part of the second coil end 23b in the axial direction of the rotary shaft 17. A plurality of the second oil supply holes 62 are formed in the peripheral wall 12b in a state where openings of the second oil supply holes 62 on a side of the second coil end 23b are arranged side by side in the circumferential direction of the rotary shaft 17. In the present embodiment, the number of second oil supply holes 62 formed in the peripheral wall 12b is two. Consequently, two first oil supply holes 61 and two second oil supply holes 62 are formed in the peripheral wall 12b.

The openings of the two second oil supply holes 62 on the side of the second coil end 23b are formed on the peripheral wall 12b so as to be at the same position in the direction of gravity when the electric supercharger 10 is disposed horizontally. The electric supercharger 10 according to the present embodiment is mounted in the engine room such that the openings of the two second oil supply holes 62 on the side of the second coil end 23b are at the same position in the direction of gravity. The electric supercharger 10 is mounted in the engine room such that the openings of the two second oil supply holes 62 on the side of the second coil end 23b are located above the rotary shaft 17 in the direction of gravity.

At a position on the peripheral wall 12b overlapping the second coil end 23b in the radial direction of the rotary shaft 17, a second relay flow path 72 is formed. The second relay flow path 72 is orthogonal to the oil supply flow path 51, communicates with the oil supply flow path 51, and extends in the direction intersecting with the radial direction of the rotary shaft 17. The second relay flow path 72 has a circular hole shape. The second relay flow path 72 extends in the direction orthogonal to the radial direction of the rotary shaft 17. For example, the second relay flow path 72 is formed by drilling the outer peripheral surface of the peripheral wall 12b. The direction that the second relay flow path 72 is opened to the outer peripheral surface of the peripheral wall 12b is the same as the direction that the first relay flow path 71 is opened to the outer peripheral surface of the peripheral wall 12b. The opening of the second relay flow path 72 on the side of the outer peripheral surface of the peripheral wall 12b is closed by a closing member 72a.

As illustrated in FIG. 6, two second oil supply holes 62 communicate with the second relay flow path 72. The two second oil supply holes 62 extend in parallel with each other, and also extend in a direction orthogonal to the direction that the second relay flow path 72 extends and in the direction orthogonal to the axial direction of the rotary shaft 17. For example, the two second oil supply holes 62 are formed by drilling the outer peripheral surface of the peripheral wall 12b. The two second oil supply holes 62 are thus drilled holes that extend straight from the outer peripheral surface of the peripheral wall 12b to the inner peripheral surface of the peripheral wall 12b and penetrate the peripheral wall 12b. Openings of the two second oil supply holes 62 on the side of the outer peripheral surface of the peripheral wall 12b are closed by closing members 62a.

One of the two second oil supply holes 62 communicates with a middle portion of the second relay flow path 72. The other of the two second oil supply holes 62 communicates with an end of the second relay flow path 72 opposite to the opening of the second relay flow path 72 on the side of the outer peripheral surface of the peripheral wall 12b. Consequently, a part of the oil from the oil supply flow path 51 flows through the second relay flow path 72 into the two second oil supply holes 62. The two second oil supply holes 62 supply the oil to the second coil end 23b. In the present embodiment, a shortest distance H2 between axes L2 of the two second oil supply holes 62 is set to be about 1/6 of an outer diameter R2 of the second coil end 23b.

When the peripheral wall 12b is viewed in the axial direction of the rotary shaft 17, the electric supercharger 10 is mounted in the engine room such that one of the two second oil supply holes 62 is disposed on one side of both sides sandwiching the perpendicular line L20, and the other of the two second oil supply holes 62 is disposed on the other side of the both sides sandwiching the perpendicular line L20. Consequently, when the peripheral wall 12b is viewed in the axial direction of the rotary shaft 17, one of the openings of the second oil supply holes 62 on the side of the second coil end 23b is disposed on each of the both sides sandwiching the perpendicular line L20.

As illustrated in FIG. 4, an oil introduction pipe 58 is attached to the first connection hole 12m. A part of the oil stored in an oil pan of the engine flows through the oil introduction pipe 58. The oil flowing through the oil introduction pipe 58 is then supplied to the oil supply flow path 51. A closing member 59 is attached to the second connection hole 12n. The closing member 59 is attached to the second connection hole 12n after the second oil supply pipe 56 is attached to the second pipe attachment hole 12f.

As illustrated in FIG. 1, a discharge passage 20k that discharges oil in the motor chamber 20 to the outside of the housing 11 is formed in the peripheral wall 12b of the motor housing 12 opposite to the oil supply flow path 51. The electric supercharger 10 according to the present embodiment is mounted in the engine room such that the oil supply flow path 51 is located above the rotary shaft 17 in the direction of gravity, and the discharge passage 20k and the second oil discharge passage 12k are located below the rotary shaft 17 in the direction of gravity. As illustrated in FIG. 2, the seal plate 40 is attached to the motor housing 12 such that the deflector 40g is located closer to the oil supply flow path 51 in the radial direction of the rotary shaft 17, and the first oil discharge passage 40k is located closer to the discharge passage 20k in the radial direction of the rotary shaft 17. Consequently, the deflector 40g is located above the rotary shaft 17 in the direction of gravity, and the first oil discharge passage 40k is located below the rotary shaft 17 in the direction of gravity.

As illustrated in FIG. 1, the first oil discharge passage 40k and the discharge passage 20k discharge the oil supplied to the first bearing 31 to the outside of the housing 11, The second oil discharge passage 12k and the discharge passage 20k discharge the oil supplied to the second bearing 32 to the outside of the housing 11.

Next, an operation of the present embodiment will be described. As illustrated in FIG. 4, a part of the oil supplied from the oil introduction pipe 58 to the oil supply flow path 51 and filled in the oil supply flow path 51 flows into the first supply path 55a of the first oil supply pipe 55 and the second supply path 56a of the second oil supply pipe 56. The oil having flowed into the first supply path 55a and the oil having flowed into the second supply path 56a pass through the first in-shaft passage 551a and the second in-shaft passage 561a, respectively.

The oil having passed through the first in-shaft passage 551a is ejected from the first ejection hole 552a to the space between the first inner race 31a and the first outer race 31b. At this time, the flow path cross-sectional area of the first ejection hole 552a is smaller than the flow path cross-sectional area of the first in-shaft passage 551a, and thus the oil is throttled when passing through the first ejection hole 552a, and is ejected with great force from the first ejection hole 552a to the space between the first inner race 31a and the first outer race 31b. As a result, the oil is efficiently supplied to the space between the first inner race 31a and the first outer race 31b, and the slidability between the first outer race 31b and each of the first rolling elements 31c and between the first inner race 31a and each of the first rolling elements 31c is improved.

As illustrated in FIG. 2, the oil having passed through the space between the first inner race 31a and the first outer race 31b collides with the deflector 40g and is guided to the first oil discharge passage 40k by the deflector 40g, thus flowing from the inside of the engaging part 40e to the first oil discharge passage 40k. The oil then passes through the first oil discharge passage 40k to flow into the motor chamber 20, is discharged to the outside of the housing 11 through the discharge passage 20k, and is returned to the oil pan of the engine.

As illustrated in FIG. 3, the oil having passed through the second in-shaft passage 561a is ejected from the second ejection hole 562a to the space between the second inner race 32a and the second outer race 32b. At this time, the flow path cross-sectional area of the second ejection hole 562a is smaller than the flow path cross-sectional area of the second in-shaft passage 561a, and thus the oil is throttled when passing through the second ejection hole 562a, and is ejected with great force from the second ejection hole 562a to the space between the second inner race 32a and the second outer race 32b. As a result, the oil is efficiently supplied to the space between the second inner race 32a and the second outer race 32b, and the slidability between the second outer race 32b and each of the second rolling elements 32c and between the second inner race 32a and each of the second rolling elements 32c is improved.

The oil having passed through the space between the second inner race 32a and the second outer race 32b flows into the housing chamber 34 and also flows from the housing chamber 34 into the second oil discharge passage 12k. The oil then passes through the second oil discharge passage 12k to flow into the motor chamber 20, is discharged to the outside of the housing 11 through the discharge passage 20k, and is returned to the oil pan of the engine.

As illustrated in FIG. 4 and FIG. 5, a part of the oil filled in the oil supply flow path 51 flows through the first relay flow path 71 into the two first oil supply holes 61, and passes through the first oil supply holes 61. The oil flowing out of each of the first oil supply holes 61 flows on an outer peripheral surface of the first coil end 23a in the circumferential direction of the rotary shaft 17 as indicated by arrows Y1 in FIG. 5. In addition, the oil also flows on the outer peripheral surface of the first coil end 23a in the axial direction of the rotary shaft 17 to be supplied to the first coil end 23a as indicated by arrows Y11 in FIG. 4.

As illustrated in FIG. 4 and FIG. 6, a part of the oil filled in the oil supply flow path 51 flows through the second relay flow path 72 into the two second oil supply holes 62, and passes through the second oil supply holes 62. The oil flowing out of each of the second oil supply holes 62 flows on an outer peripheral surface of the second coil end 23b in the circumferential direction of the rotary shaft 17 as indicated by arrows Y2 in FIG. 6. In addition, the oil also flows on the outer peripheral surface of the second coil end 23b in the axial direction of the rotary shaft 17 to be supplied to the second coil end 23b as indicated by arrows Y12 in FIG. 4.

As a result, the first coil end 23a and the second coil end 23b are cooled, and thus the coil 23 of the electric motor 19 is cooled. The oil contributed to cooling of the first coil end 23a and the second coil end 23b is discharged to the outside of the housing 11 through the discharge passage 20k, and is returned to the oil pan of the engine.

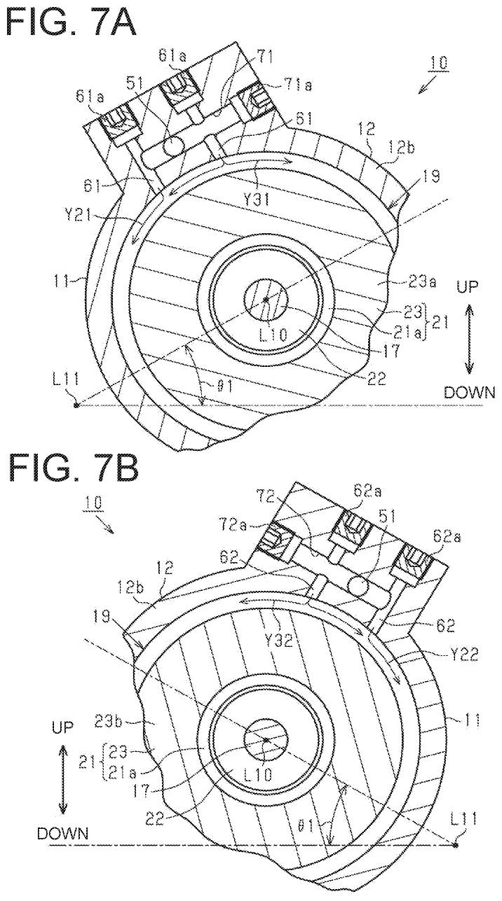

As illustrated in FIG. 7A and FIG. 7B, if the posture of the automobile is changed, the entire electric supercharger 10 may be tilted so as to turn about a virtual straight line L11 extending parallel to the axis L10 of the rotary shaft 17, the virtual straight line L11 functioning as a turning center. Here, it is assumed that the electric supercharger 10, which is disposed horizontally, is turned about the virtual straight line L11 functioning as the turning center.

The turning direction of the electric supercharger 10 is assumed to be, for example, a direction that the first oil supply hole 61 communicating with the middle portion of the first relay flow path 71, of two first oil supply holes 61, is moved to the first oil supply hole 61 communicating with the end of the first relay flow path 71 opposite to the opening of the first relay flow path 71 on the side of the outer peripheral surface of the peripheral wall 12b. The turning direction of the electric supercharger 10 is not particularly limited, and, for example, may be a direction that the first oil supply hole 61 communicating with the end of the first relay flow path 71 opposite to the opening of the first relay flow path 71 on the side of the outer peripheral surface of the peripheral wall 12b, of the two first oil supply holes 61, is moved to the first oil supply hole 61 communicating with the middle portion of the first relay flow path 71.

Further, it is assumed that a turning angle θ1 of the electric supercharger 10 disposed horizontally about the virtual straight line L11 functioning as the turning center of the electric supercharger 10 is 30 degrees. The turning angle θ1 of the electric supercharger 10, which is disposed horizontally, due to the change of the posture of the automobile is ±30 degrees at most.

In this case, for example, if only one first oil supply hole 61 is formed in the peripheral wall 12b, the oil flowing from the first oil supply hole 61 to the first coil end 23a may flow unevenly toward one side in the circumferential direction of the rotary shaft 17. In addition, for example, if only one second oil supply hole 62 is formed in the peripheral wall 12b, the oil flowing from the second oil supply hole 62 to the second coil end 23b may flow unevenly toward one side in the circumferential direction of the rotary shaft 17.

Consequently, two first oil supply holes 61 are formed in the peripheral wall 12b in a state where openings of the first oil supply holes 61 on the side of the first coil end 23a are arranged side by side in the circumferential direction of the rotary shaft 17. For this reason, if the entire electric supercharger 10 is tilted for example, it becomes hard for the oil flowing from the two first oil supply holes 61 to the first coil end 23a to flow unenvely toward one side in the circumferential direction of the rotary shaft 17, as compared to the case where only one first oil supply hole 61 is formed in the peripheral wall 12b. Specifically, the oil flowing, of the two first oil supply holes 61, from the first oil supply hole 61 communicating with the end of the first relay flow path 71 opposite to the opening of the first relay flow path 71 on the side of the outer peripheral surface of the peripheral wall 12b to the first coil end 23a tends to flow unevenly toward one side in the circumferential direction of the rotary shaft 17, as indicated by an arrow Y21 in FIG. 7A. On the other hand, the oil flowing, of the two first oil supply holes 61, from the first oil supply hole 61 communicating with the middle portion of the first relay flow path 71 to the first coil end 23a flows toward both sides in the circumferential direction of the rotary shaft 17 as indicated by arrows Y31 in FIG, 7A.

In addition, two second oil supply holes 62 are formed in the peripheral wall 12b in a state where openings of the second oil supply holes 62 on the side of the second coil end 23b are arranged side by side in the circumferential direction of the rotary shaft 17. For this reason, if the entire electric supercharger 10 is tilted for example, it becomes hard for the oil flowing from the two second oil supply holes 62 to the second coil end 23b to flow unevenly toward one side in the circumferential direction of the rotary shaft 17, as compared to the case where only one second oil supply hole 62 is formed in the peripheral wall 12b. Specifically, the oil flowing, of the two second oil supply holes 62, from the second oil supply hole 62 communicating with the end of the second relay flow path 72 opposite to the opening of the second relay flow path 72 on the side of the outer peripheral surface of the peripheral wall 12b to the second coil end 23b tends to flow unevenly toward one side in the circumferential direction of the rotary shaft 17, as indicated by an arrow Y22 in FIG. 7B. On the other hand, the oil flowing, of the two second oil supply holes 62, from the second oil supply hole 62 communicating with the middle portion of the second relay flow path 72 to the second coil end 23b flows toward both sides in the circumferential direction of the rotary shaft 17 as indicated by arrows Y32 in FIG. 7B.

Further, due to a change of the posture of the automobile, the entire electric supercharger 10 may be tilted such that, for example, a side of the compressor housing 13 is displaced downward in the direction of gravity and a side of the cover 15 is displaced upward in the direction of gravity. In this case, each of the first oil supply holes 61 is opened on the inner peripheral surface of the peripheral wall 12b at the position overlapping, in the radial direction of the rotary shaft 17, the center part of the first coil end 23a in the axial direction of the rotary shaft 17, Consequently, it becomes hard for the oil flowing from each of the first oil supply holes 61 to the first coil end 23a to flow unevenly toward one side in the axial direction of the rotary shaft 17 as compared to a case where each of the first oil supply holes 61 is opened on the inner peripheral surface of the peripheral wall 12b at the position overlapping, in the radial direction of the rotary shaft 17, an end of the first coil end 23a in the axial direction of the rotary shaft 17, for example.

In addition, each of the second oil supply holes 62 is opened on the inner peripheral surface of the peripheral wall 12b at the position overlapping, in the radial direction of the rotary shaft 17, a center part of the second coil end 23b in the axial direction of the rotary shaft 17. Consequently, it becomes hard for the oil flowing from each of the second oil supply holes 62 to the second coil end 23b to flow unevenly toward one side in the axial direction of the rotary shaft 17 as compared to a case where each of the second oil supply holes 62 is opened on the inner peripheral surface of the peripheral wall 12b at the position overlapping, in the radial direction of the rotary shaft 17, an end of the second coil end 23b in the axial direction of the rotary shaft 17, for example.

Therefore, even if the entire electric supercharger 10 is tilted, the entire first coil end 23a becomes easy to be cooled uniformly by the oil supplied from two first oil supply holes 61 to the first coil end 23a, and the entire second coil end 23b also becomes easy to be cooled uniformly by the oil supplied from two second oil supply holes 62 to the second coil end 23b.

The embodiment described above has the following effects.

(1) A plurality of the first oil supply holes 61 are formed in the peripheral wall 12b in a state where openings of the first oil supply holes 61 on the side of the first coil end 23a are arranged side by side in the circumferential direction of the rotary shaft 17. A plurality of the second oil supply holes 62 are formed in the peripheral wall 12b in a state where openings of the second oil supply holes 62 on a side of the second coil end 23b are arranged side by side in the circumferential direction of the rotary shaft 17. According to this configuration, if the entire electric supercharger 10 is tilted for example, it becomes hard for the oil flowing from the first oil supply holes 61 to the first coil end 23a to flow unevenly toward one side in the circumferential direction of the rotary shaft 17, as compared to the case where only one first oil supply hole 61 is formed in the peripheral wall 12b. In addition, if the entire electric supercharger 10 is tilted for example, it becomes hard for the oil flowing from the two second oil supply holes 62 to the second coil end 23b to flow unevenly toward one side in the circumferential direction of the rotary shaft 17, as compared to the case where only one second oil supply hole 62 is formed in the peripheral wall 12b. Therefore, even if the entire electric supercharger 10 is tilted, the entire first coil end 23a becomes easy to be cooled uniformly by the oil supplied from the first oil supply holes 61 to the first coil end 23a, and the entire second coil end 23b also becomes easy to be cooled uniformly by the oil supplied from the second oil supply holes 62 to the second coil end 23b. As a result, the coil 23 of the electric motor 19 is efficiently cooled.

(2) The oil supply flow path 51 that extends in the axial direction of the rotary shaft 17 and through which oil flows is formed in the peripheral wall 12b. The oil from the oil supply flow path 51 flows in the first oil supply holes 61 and the second oil supply holes 62. According to this configuration, the oil flowing in the oil supply flow path 51 is supplied to the first oil supply holes 61 and the second oil supply holes 62. It is thus unnecessary to separately form a flow path for supplying oil to the first oil supply holes 61 and a flow path for supplying oil to the second oil supply holes 62 in the peripheral wall 12b. Consequently, the configuration of the peripheral wall 12b is simplified.

(3) The first oil supply holes 61 communicate with the first relay flow path 71, and the second oil supply holes 62 communicate with the second relay flow path 72. According to this configuration, a part of the oil flowing in the oil supply flow path 51 flows through the first relay flow path 71 into the first oil supply holes 61, and a part of the oil flowing in the oil supply flow path 51 also flows through the second relay flow path 72 into the second oil supply holes 62. Consequently, the operation of making the first oil supply holes 61 and the second oil supply holes 62 in the peripheral wall 12b is performed more easily than in a case where the first oil supply holes 61 directly communicate with the oil supply flow path 51 or a case where the second oil supply holes 62 directly communicate with the oil supply flow path 51.

(4) The openings of the first oil supply holes 61 on the side of the first coil end 23a and the openings of the second oil supply holes 62 on the side of the second coil end 23b are located above the rotary shaft 17 in the direction of gravity. According to this configuration, even if the entire electric supercharger 10 is tilted, the entire first coil end 23a becomes easy to be cooled uniformly by the oil supplied from the first oil supply holes 61 to the first coil end 23a, and the entire second coil end 23b also becomes easy to be cooled uniformly by the oil supplied from the second oil supply holes 62 to the second coil end 23b. As a result, the coil 23 of the electric motor 19 is efficiently cooled.

(5) When the peripheral wall 12b is viewed in the axial direction of the rotary shaft 17, one of the openings of the first oil supply holes 61 on the side of the first coil end 23a is disposed on each of the both sides sandwiching the perpendicular line L20. Further, when the peripheral wall 12b is viewed in the axial direction of the rotary shaft 17, one of the openings of the second oil supply holes 62 on the side of the second coil end 23b is disposed on each of the both sides sandwiching the perpendicular line L20. For example, it is assumed that, when the peripheral wall 12b is viewed in the axial direction of the rotary shaft 17, all the openings of the first oil supply holes 61 on the side of the first coil end 23a are disposed on one of the both sides sandwiching the perpendicular line L20. Compared to this case, if the entire electric supercharger 10 is tilted, the oil flowing from the first oil supply holes 61 to the first coil end 23a becomes hard to flow unevenly toward one side in the circumferential direction of the rotary shaft 17. For example, it is assumed that, when the peripheral wall 12b is viewed in the axial direction of the rotary shaft 17, all the openings of the second oil supply holes 62 on the side of the second coil end 23b are disposed on one of the both sides sandwiching the perpendicular line L20. Compared to this case, if the entire electric supercharger 10 is tilted, the oil flowing from the second oil supply holes 62 to the second coil end 23b becomes hard to flow unevenly toward one side in the circumferential direction of the rotary shaft 17.

(6) Two first oil supply holes 61 and two second oil supply holes 62 are formed in the peripheral wall 12b. According to this configuration, it is possible to supply oil efficiently to the first coil end 23a and the second coil end 23b with a reduced number of the first oil supply holes 61 and the second oil supply holes 62 formed in the peripheral wall 12b,

(7) The first oil supply holes 61 and the second oil supply holes 62 are drilled holes that extend straight from the outer peripheral surface of the peripheral wall 12b to the inner peripheral surface of the peripheral wall 12b and penetrate the peripheral wall 12b. According to this configuration, for example, the first oil supply holes 61 and the second oil supply holes 62 are made in the peripheral wall 12b only by drilling the outer peripheral surface of the peripheral wall 12b. Consequently, it is unnecessary to add, for example, a member different from the motor housing 12 in order to make the first oil supply holes 61 and the second oil supply holes 62 in the electric supercharger 10. Further, it is possible to prevent the shape of the motor housing 12 from becoming complicated because, for example, the motor housing 12 is molded using a core in order to make the first oil supply holes 61 and the second oil supply holes 62 in the motor housing 12.

(8) Each of the first oil supply holes 61 is opened on the inner peripheral surface of the peripheral wall 12b at the position overlapping, in the radial direction of the rotary shaft 17, the center part of the first coil end 23a in the axial direction of the rotary shaft 17. Each of the second oil supply holes 62 is opened on the inner peripheral surface of the peripheral wall 12b at the position overlapping, in the radial direction of the rotary shaft 17, the center part of the second coil end 23b in the axial direction of the rotary shaft 17. According to this configuration, it becomes hard for the oil flowing from each of the first oil supply holes 61 to the first coil end 23a to flow unevenly toward one side in the axial direction of the rotary shaft 17 as compared to a case where each of the first oil supply holes 61 is opened on the inner peripheral surface of the peripheral wall 12b at the position overlapping, in the radial direction of the rotary shaft 17, the end of the first coil end 23a in the axial direction of the rotary shaft 17, for example. In addition, it becomes hard for the oil flowing from each of the second oil supply holes 62 to the second coil end 23b to flow unenvely toward one side in the axial direction of the rotary shaft 17 as compared to a case where each of the second oil supply holes 62 is opened on the inner peripheral surface of the peripheral wall 12b at the position overlapping, in the radial direction of the rotary shaft 17, the end of the second coil end 23b in the axial direction of the rotary shaft 17, for example.

The embodiment described above may be modified and implemented as follows. The embodiment described above and the following modifications may be implemented in combination with each other within a technically consistent range.

In the embodiment, the electric supercharger 10 may be configured such that a flow path for supplying oil to the first oil supply holes 61 and a flow path for supplying oil to the second oil supply holes 62 are separately formed in the peripheral wall 12b.

In the embodiment, the electric supercharger 10 may be configured such that, for example, the first oil supply holes 61 directly communicate with the oil supply flow path 51.

In the embodiment, the electric supercharger 10 may be configured such that, for5 example, the second oil supply holes 62 directly communicate with the oil supply flow path 51.

In the embodiment, the electric supercharger 10 may be configured such that a flow path forming member including the oil supply flow path 51, the first oil supply holes 61, the second oil supply holes 62, the first relay flow path 71, and the second relay flow path 72 is detachable from the peripheral wall 12b of the motor housing 12. In this case, the flow path forming member is attached to the peripheral wall 12b of the motor housing 12 to constitute a part of a peripheral wall of the housing 11.

In the embodiment, the shortest distance H1 between the axes L1 of the two first oil supply holes 61 is set to about 1/6 of the outer diameter R1 of the first coil end 23a. However, the interval between the two first oil supply holes 61 in the circumferential direction of rotary shaft 17 is not particularly limited. Consequently, for example, the opening of one of the two first oil supply holes 61 on the side of the first coil end 23a may be located above the rotary shaft 17 in the direction of gravity, and the opening of the other of the two first oil supply holes 61 on the side of the first coil end 23a may be located below the rotary shaft 17 in the direction of gravity.

In the embodiment, the shortest distance H2 between the axes L2 of the two second oil supply holes 62 is set to about 1/6 of the outer diameter R2 of the second coil end 23b. However, the interval between the two second oil supply holes 62 in the circumferential direction of rotary shaft 17 is not particularly limited. Consequently, for example, the opening of one of the two second oil supply holes 62 on the side of the second coil end 23b may be located above the rotary shaft 17 in the direction of gravity, and the opening of the other of the two second oil supply holes 62 on the side of the second coil end 23b may be located below the rotary shaft 17 in the direction of gravity.

In the embodiment, three or more first oil supply holes 61 and three or more second oil supply holes 62 may be formed in the peripheral wall 12b. In this case also, when the peripheral wall 12b is viewed in the axial direction of the rotary shaft 17, at least one of the openings of the first oil supply holes 61 on the side of the first coil end 23a is preferably disposed on each of the both sides sandwiching the perpendicular line L20. In addition, when the peripheral wall 12b is viewed in the axial direction of the rotary shaft 17, at least one of the openings of the second oil supply holes 62 on the side of the second coil end 23b is preferably disposed on each of the both sides sandwiching the perpendicular line L20.

In the embodiment, the oil supply flow path 51 may be formed by drilling an outer surface of the bottom wall 12a of the motor housing 12, for example. In this case, the opening of the oil supply flow path 51 on the side of the bottom wall 12a of the motor housing 12 is closed by a closing member.

In the embodiment, the shape of the oil supply flow path 51, the first oil supply holes 61, the second oil supply holes 62, the first relay flow path 71, and the second relay flow path 72 is not particularly limited, and may be, for example, a rectangular hole shape.

In the embodiment, the first relay flow path 71 may extend in a direction oblique to the radial direction of the rotary shaft 17. It is only required that the first relay flow path 71 is orthogonal to the oil supply flow path 51, communicates with the oil supply flow path 51, and extends in the direction intersecting with the radial direction of the rotary shaft 17.

In the embodiment, the second relay flow path 72 may extend in a direction oblique to the radial direction of the rotary shaft 17. It is only required that the second relay flow path 72 is orthogonal to the oil supply flow path 51, communicates with the oil supply flow path 51, and extends in the direction intersecting with the radial direction of the rotary shaft 17.

In the embodiment, each of the first oil supply holes 61 may be opened on the inner peripheral surface of the peripheral wall 12b at the position overlapping, in the radial direction of the rotary shaft 17, the end of the first coil end 23a in the axial direction of the rotary shaft 17.

In the embodiment, each of the second oil supply holes 62 may be opened on the inner peripheral surface of the peripheral wall 12b at the position overlapping, in the radial direction of the rotary shaft 17, the end of the second coil end 23b in the axial direction of the rotary shaft 17.

In the embodiment, the openings of the two first oil supply holes 61 on the side of the first coil end 23a may be arranged at positions shifted from each other in the axial direction of the rotary shaft 17.

In the embodiment, the openings of the two second oil supply holes 62 on the side of the second coil end 23b may be arranged at positions shifted from each other in the axial direction of the rotary shaft 17.

In the embodiment, the electric supercharger 10 may be mounted in the engine room in a state where positions of the openings of the two first oil supply holes 61 on the side of the first coil end 23a are shifted from each other in the direction of gravity, and positions of the openings of the two second oil supply holes 62 on the side of the second coil end 23b are shifted from each other in the direction of gravity. That is, the electric supercharger 10 may be mounted on the engine room in an inclined state. In this case also, when the peripheral wall 12b is viewed in the axial direction of the rotary shaft 17, one of the openings of the first oil supply hole 61 on the side of the first coil end 23a is preferably disposed on each of the both sides sandwiching the perpendicular line L20. In addition, when the peripheral wall 12b is viewed in the axial direction of the rotary shaft 17, one of the openings of the second oil supply hole 62 on the side of the second coil end 23b is preferably disposed on each of the both sides sandwiching the perpendicular line L20.

In the embodiment, the electric supercharger 10 is mounted in the engine room of the automobile. However, the present disclosure is not limited to this case, the object in which the electric supercharger 10 is to be mounted is not particularly limited.

What is claimed is:

1. An electric supercharger comprising:
a housing including a peripheral wall that has a cylindrical shape,
a rotary shaft housed in the housing;
an impeller connected to an axial end of the rotary shaft; and
an electric motor that is housed in the housing and rotates the rotary shaft, wherein the electric motor includes a stator in which a coil is wound, wherein the stator includes a stator core having a cylindrical shape, and a first coil end and a second coil end that are parts of the coil and project from both end surfaces of the stator core located in an axial direction of the rotary shaft,
wherein
the peripheral wall includes
a plurality of first oil supply holes through which oil flows and that are opened on an inner peripheral surface of the peripheral wall at positions overlapping the first coil end in a radial direction of the rotary shaft, and
a plurality of second oil supply holes through which oil flows and that are opened on the inner peripheral surface of the peripheral wall at positions overlapping the second coil end in the radial direction of the rotary shaft,
wherein the plurality of first oil supply holes are formed in the peripheral wall in a state where openings of the first oil supply holes on a side of the first coil end are arranged side by side in a circumferential direction of the rotary shaft, and
wherein the plurality of second oil supply holes are formed in the peripheral wall in a state where openings of the second oil supply holes on a side of the second coil end are arranged side by side in the circumferential direction of the rotary shaft.

2. The electric supercharger according to claim 1, wherein
an oil supply flow path that extends in the axial direction of the rotary shaft and through which oil flows is formed in the peripheral wall, and
oil from the oil supply flow path flows in the plurality of first oil supply holes and the plurality of second oil supply holes.

3. The electric supercharger according to claim 2, wherein
a first relay flow path is formed at a position on the peripheral wall overlapping the first coil end in the radial direction of the rotary shaft, and the first relay flow path is orthogonal to the oil supply flow path, communicates with the oil supply flow path, and extends in a direction intersecting with the radial direction of the rotary shaft,
a second relay flow path is formed at a position on the peripheral wall overlapping the second coil end in the radial direction of the rotary shaft, and the second relay flow path is orthogonal to the oil supply flow path, communicates with the oil supply flow path, and extends in the direction intersecting with the radial direction of the rotary shaft,
the plurality of first oil supply holes communicate with the first relay flow path, and
the plurality of second oil supply holes communicate with the second relay flow path.

4. The electric supercharger according to claim 1, wherein the openings of the plurality of first oil supply holes on the side of the first coil end and the openings of the plurality of second oil supply holes on the side of the second coil end are located above the rotary shaft in a direction of gravity.

5. The electric supercharger according to claim 1, wherein
when the peripheral wall is viewed in the axial direction of the rotary shaft, at least one of the openings of the first oil supply holes on the side of the first coil end is disposed on each of both sides sandwiching a perpendicular line that is orthogonal to an axis of the rotary shaft and extends in a direction of gravity, and
when the peripheral wall is viewed in the axial direction of the rotary shaft, at least one of the openings of the second oil supply holes on the side of the second coil end is disposed on each of the both sides sandwiching the perpendicular line.

6. The electric supercharger according to claim 1, wherein two of the first oil supply holes and two of the second oil supply holes are formed in the peripheral wall.

7. The electric supercharger according to claim 1, wherein the first oil supply holes and the second oil supply holes are drilled holes that extend straight from an outer peripheral surface of the peripheral wall to the inner peripheral surface of the peripheral wall and penetrate the peripheral wall.
